(19) United States
(12) Patent Application Publication
(10) Pub. No.: US 2020/0183805 A1
(43) Pub. Date: Jun. 11, 2020

(54) LOG ANALYSIS METHOD, SYSTEM, AND PROGRAM

(71) Applicant: NEC CORPORATION, Tokyo (JP)

(72) Inventor: Ryosuke TOGAWA, Tokyo (JP)

(73) Assignee: NEC Corporation, Tokyo (JP)

(21) Appl. No.: 16/339,016

(22) PCT Filed: Oct. 13, 2016
(86) PCT No.: PCT/JP2016/004562

§ 371 Date: Apr. 3, 2019

(51) Int. Cl. G06F 11/30; G06F 11/32; G06F 11/07; G06K 9/62

(52) U.S. Cl. CPC G06F 11/3075; G06F 11/324; G06K 9/6257; G06F 11/0772; G06F 11/0757

(57) ABSTRACT

The present invention provides a log analysis method, a system, and a program that can accurately output information associated with a particular event without prior knowledge of a log content. A log analysis system 100 according to one example embodiment of the present invention includes: a log input unit 110 that inputs at least one analysis target log including a plurality of logs; a correlation determination unit 130 that determines presence or absence of a time series correlation between the plurality of logs within a predetermined time range before or after an event; and an event detection unit 140 that detects the event based on a result of the determination by the correlation determination unit. Therefore, the log analysis system outputs information on a known event without using prior knowledge of the log content (meaning of a log message or the like).

### TECHNICAL FIELD

The present invention relates to a log analysis method, a system, and a program for performing log analysis.

### BACKGROUND ART

In systems executed on computers, in general, a log including a result of an event, a message, or the like is output. When a system anomaly or the like occurs, log analysis is performed based on a large number of logs. Especially in recent years, since the scale of such a system has increased causing the increased number of logs, it is difficult for a user (an operator or the like) to track associated logs by visual observation. It is therefore desirable to extract only a log associated to a particular event such as an anomaly by the system.

Conventional log analysis technology using prior knowledge of a log content (meaning of a log message or the like) cannot analyze logs if no prior knowledge is provided. In contrast, the technology disclosed in Patent Literature 1 estimates that logs output from the same output source (host) within a short time difference are correlated and outputs the result. With such a configuration, even when no prior knowledge is provided, logs associated to the same event can be extracted.

### CITATION LIST

### Patent Literature

PTL 1: International Publication No. 2016/031681

### SUMMARY OF INVENTION

### Technical Problem

In a general system, various types of logs are output from multiple types of devices and programs. Thus, even logs associated with the same event may occur at significantly different output time due to different timings of the process or the like. However, since the technology disclosed in Patent Literature 1 simply estimates that logs having close occurrence time are correlated, association between logs occurring at separate time cannot be detected.

The present invention has been made in view of the above problem and intends to provide a log analysis method, a system, and a program that can accurately output information associated with a particular event without prior knowledge of a log content.

A first example aspect of the present invention is a log analysis method including steps of: inputting at least one analysis target log including a plurality of logs; determining presence or absence of a time series correlation between the plurality of logs within a predetermined time range before or after an event; and detecting the event based on a result of the determination.

A second example aspect of the present invention is a log analysis program that causes a computer to execute steps of: inputting at least one analysis target log including a plurality of logs; determining presence or absence of a time series correlation between the plurality of logs within a predetermined time range before or after an event; and detecting the event based on a result of the determination.

A third example aspect of the present invention is a log analysis system including: a log input unit that inputs at least one analysis target log including a plurality of logs; a correlation determination unit that determines presence or absence of a time series correlation between the plurality of logs within a predetermined time range before or after an event; and an event detection unit that detects the event based on a result of the determination.

According to the present invention, since an event is detected based on a time series correlation between a plurality of logs within a predetermined time range before or after the event, information related to a known event can be output even when no prior knowledge on a log content is provided.

### BRIEF DESCRIPTION OF DRAWINGS

FIG. 1 is a block diagram of a log analysis system according to a first example embodiment.

FIG. 2A is a schematic diagram of an analysis target log according to the first example embodiment.

FIG. 2B is a schematic diagram of a format according to the first example embodiment.

FIG. 3 is a schematic diagram of a log analysis method according to the first example embodiment.

FIG. 4 is a schematic diagram of an exemplary correlation pattern according to the first example embodiment.

FIG. 5 is a general configuration diagram of the log analysis system according to the first example embodiment.

FIG. 6 is a diagram illustrating a flowchart of the log analysis method according to the first example embodiment.

FIG. 7 is a block diagram of a log analysis system according to a second example embodiment.

FIG. 8 is a diagram illustrating a flowchart of the log analysis method according to the second example embodiment.

FIG. 9 is a block diagram of a log analysis system according to a third example embodiment.

FIG. 10 is a diagram illustrating a flowchart of the log analysis method according to the third example embodiment.

FIG. 11 is a block diagram of the log analysis system according to each example embodiment.

### DESCRIPTION OF EMBODIMENTS

While example embodiments of the present invention will be described below with reference to the drawings, the present invention is not limited to the present example embodiments. Note that, in the drawings described below, components having the same function are labeled with the same reference symbols, and the duplicated description thereof may be omitted.

### First Example Embodiment

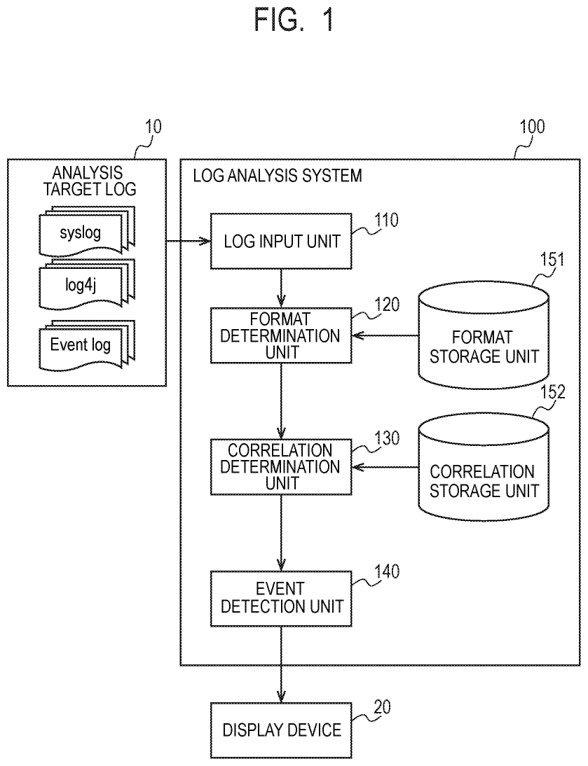

FIG. 1 is a block diagram of a log analysis system 100 according to the present example embodiment. In FIG. 1, arrows represent main dataflows, and there may be other dataflows than those illustrated in FIG. 1. In FIG. 1, each block illustrates a configuration in a unit of function rather than in a unit of hardware (device). Therefore, the block shown in FIG. 1 may be implemented in a single device or may be implemented independently in a plurality of devices. Transmission and reception of the data between blocks may be performed via any means, such as a data bus, a network, a portable storage medium, or the like.

The log analysis system 100 has, as a processing unit, a log input unit 110, a format determination unit 120, a correlation determination unit 130, and an event detection unit 140. Further, the log analysis system 100 has, as a storage unit, a format storage unit 151 and a correlation storage unit 152.

The log input unit 110 receives an analysis target log 10 to be an analysis target and inputs the received analysis target log 10 into the log analysis system 100. The analysis target log 10 may be acquired from the outside of the log analysis system 100 or may be acquired by reading pre-stored logs inside the log analysis system 100. The analysis target log 10 includes one or more logs output from one or more devices or programs. The analysis target log 10 is a log represented in any data form (file form), which may be, for example, binary data or text data. Further, the analysis target log 10 may be stored as a table of a database or may be stored as a text file.

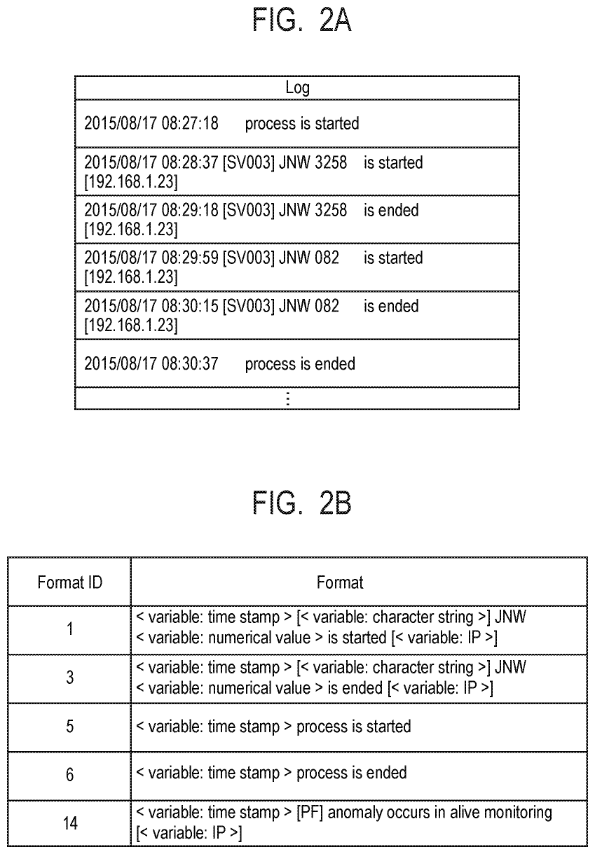

FIG. 2A is a schematic diagram of an exemplary analysis target log 10. The analysis target log 10 according to the present example embodiment includes any number of one or more logs, where one log output from a device or a program is defined as one unit. One log may be one line of character string or two or more lines of character strings. That is, the analysis target log 10 refers to the entire logs included in the analysis target log 10, and a log refers to a single log extracted from the analysis target log 10. Each log includes a time stamp, a message, and the like. The log analysis system 100 can analyze not only a specific type of logs but also broad types of logs. For example, any log that records a message output from an operating system, an application, or the like, such as syslog, an event log, or like, can be used as the analysis target log 10.

The format determination unit 120 determines which format (form) pre-stored in the format storage unit 151 each log included in the analysis target log 10 matches and then divides each log into a variable part and a constant part by using the matching format. The format is a predetermined type of a log based on characteristics of the log. The characteristics of the log include a property of being likely to vary or less likely to vary between logs similar to each other or a property of having description of a character string considered as a part which is likely to vary in the log. The variable part is a part that may vary in the format, and the constant part is a part that does not vary in the format. The value (including a numerical value, a character string, and other data) of the variable part in the input log is referred to as a variable value. The variable part and the constant part are different on a format basis. Thus, there is a possibility that the part defined as the variable part in a certain format is defined as the constant part in another format or vice versa.

FIG. 2B is a schematic diagram of an exemplary format stored in the format storage unit 151. A format includes a character string representing a format associated with a unique format ID. By describing a predetermined identifier in a part, which may vary, of a log, the format defines the variable part and defines the part of the log other than the variable part as the constant part. As an identifier of the variable part, for example, “<variable: time stamp>” indicates the variable part representing a time stamp, “<variable: character string>” indicates the variable part representing any character string, “<variable: numerical value>” indicates the variable part representing any numerical value, and “<variable: IP>” indicates the variable part representing any IP address. The identifier of a variable part is not limited thereto but may be defined by any method such as a regular expression, a list of values which may be taken, or the like. A format may be formed of only the variable part without including the constant part or only the constant part without including the variable part.

For example, the format determination unit 120 determines that the log on the third line of FIG. 2A matches the format whose ID of FIG. 2B is 1. Then, the format determination unit 120 processes the log based on the determined format and determines “2015/08/17 08:28:37”, which is time stamp, “SV003”, which is the character string, “3258”, which is the numerical value, and “192.168.1.23”, which is the IP address, as variable values.

In FIG. 2B, although the format is represented by the list of character strings for better visibility, the format may be represented in any data form (file form), for example, binary data or text data. Further, a format may be stored in the format storage unit 151 as a binary file or a text file or may be stored in the format storage unit 151 as a table of a database.

The correlation determination unit 130 and the event detection unit 140 determine the similarity to a known event by determining the presence or absence of a time series correlation (correlation pattern) stored in the correlation storage unit 152 in the analysis target log 10 and detect and output occurrence of the known event in advance or later by using a log analysis method described below.

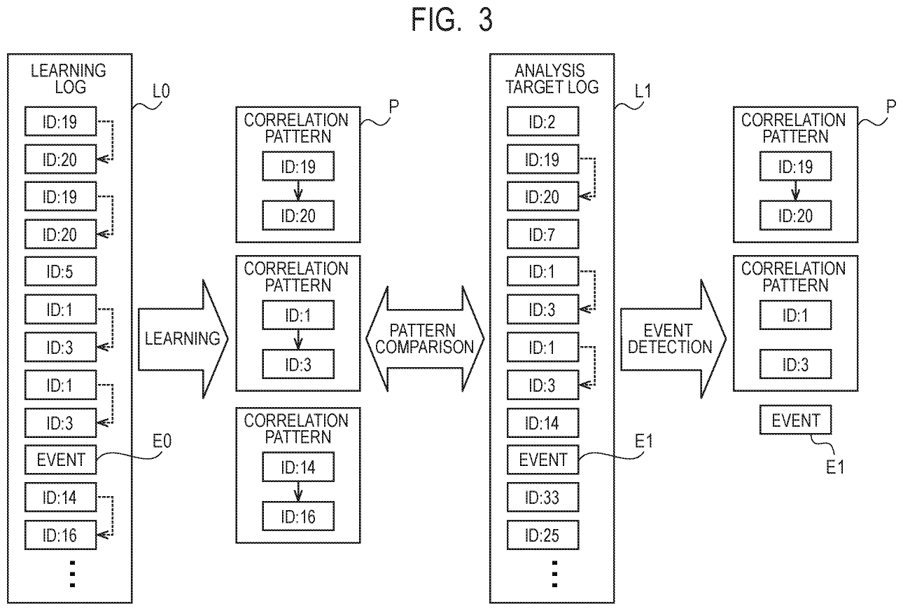

FIG. 3 is a schematic diagram of the log analysis method according to the present example embodiment. The log analysis method according to the present example embodiment finds a particular event in an analysis target log based on a correlation pattern learned by using invariant analysis. The invariant analysis is a type of correlation analysis and is to learn a correlation (also referred to as an invariant relationship) as a model by calculating a correlation coefficient between values from time series data. Then, by comparing the analysis target data with the learned model, it is possible to determine whether or not a state at the time of analysis and a state at the time of model generation are similar to each other.

First, a correlation pattern that has been learned in advance will be described by using FIG. 3. In the correlation storage unit 152, a correlation pattern P that is a time series correlation between logs before or after a known event E0 and is learned in advance from a learning log L0 is stored. That is, the correlation pattern P represents a correlation between a plurality of logs whose appearance before or after the known event E0 has been learned. The learning log L0 is a log group output within a predetermined time range including the occurrence time of the event E0. The time range of the learning log L0 is from the time of a predetermined time period before the occurrence time of the event E0 to the time of a predetermined time period after the occurrence time of the event E0. The time range of the learning log L0 may be symmetrical or asymmetrical with respect to the occurrence time of the event E0 to the past and the future. The definition of the learning log L0 is the same as the analysis target log 10. For learning of the correlation pattern P0, a single learning log L0 may be used or a plurality of learning logs L0 may be used.

The known event E0 is a particular event to be detected such as an anomaly occurring in the system itself that has output a log, an anomaly detected by a monitoring system, an event which is normal but has to be detected, or the like. The occurrence time of the event E0 may be represented by a time (a time stamp) of a single log corresponding to the event E0 in the learning log L0. When there is no log corresponding to the event E0 in the learning log L0, the occurrence time of the event E0 may be represented by a particular time within the time range of the learning log L0. That is, a log representing the event E0 may or may not be included in the learning log L0.

Specifically, for logs within a predetermined time range (for example, within 10 minutes before and after the occurrence time of the event E0) including the occurrence time of the event E0 out of the learning log L0, a transition probability between format IDs of the logs is calculated as a correlation coefficient, and a log group whose transition probability is greater than or equal to a predetermined threshold is learned as a correlation pattern P. The transition probability is calculated for temporally adjacent two logs or all the combinations of two logs output within a predetermined time period (for example, within 10 seconds). The correlation pattern P is a permutation or a combination of correlated logs (format IDs). The transition probability is a probability at which a first type of logs appears and then a second type of logs appears in the learning log L0 (or the opposite thereto) and is a larger value for a larger number of times of occurrence of the permutation or the combination thereof. In other words, a correlation between logs is learned from time series data of the number of times of occurrence of each type of logs in logs occurring before and after the event E0. The learned correlation pattern P is stored in the correlation storage unit 152 together with information used for identifying the event E0. While the format ID of logs has been used for calculating a correlation coefficient between logs in the present example embodiment, any value that can represent characteristics of logs, such as a variable value included in a log, a combination of a format ID and a variable value, or the like may be used.

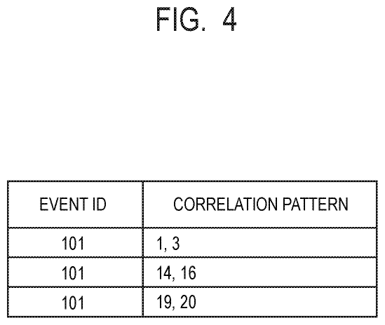

FIG. 4 is a schematic diagram of an exemplary correlation pattern stored in the correlation storage unit 152. The correlation pattern is stored in association with an event ID that identifies an event. In other words, one or more correlation patterns are stored in association with an event ID of a known event. Each correlation pattern includes two or more format IDs whose correlation has been determined before or after an event. While represented by a list of character strings for better visibility in FIG. 4, the correlation pattern may be represented in any data form (file form), for example, may be represented in binary data or text data. Further, the correlation pattern may be stored in the correlation storage unit 152 as a binary file or a text file or may be stored in the correlation storage unit 152 as a table of a database.

While the number of format IDs of logs included in each correlation pattern P is two in the example of FIG. 3 and FIG. 4, the number may be any number of two or more where the transition probability is greater than or equal to a predetermined threshold. Thereby, it is possible to learn a correlation pattern of two or more logs (formats) appearing before or after the event E0.

As a learning method of a correlation pattern, without being limited to the invariant analysis illustrated here, any method that can learn a correlation between logs from time series data of logs before or after the known event E0 may be used.

Next, an event detection method based on a correlation pattern will be described by using FIG. 3. The analysis target log L1 is the analysis target log 10 resulted after the format has been determined by the format determination unit 120. It is assumed that an event E1 to be detected occurs within a time range of the analysis target log L1. The event E1 may be known or unknown. The correlation determination unit 130 performs comparison on each log group in the analysis target log 10 to determine whether or not to be the same as or similar to the correlation pattern P stored in the correlation storage unit 152. The determination of being similar to the correlation pattern P is performed with any rule such as determining that a ratio of matching to the plurality of logs (formats) included in the correlation pattern P is greater than or equal to a predetermined threshold, determining that the plurality of logs (formats) included in the correlation pattern P have been rearranged, or the like.

Then, when the correlation pattern P associated with the known event E0 appears in the analysis target log L1 so as to satisfy a predetermined criterion, the event detection unit 140 detects that the event E0 known as the event E1 has occurred and outputs information on the event E0 and the event E1. As a detection criterion of an event, any criterion using a total value of times of appearance of the correlation pattern P, a ratio of the number of times of appearance of the correlation pattern P to the number of input logs, a rate of inclusion of all the correlation patterns P associated with a single event (event ID), or the number of times of appearance of the correlation pattern P in input logs may be used.

For detection of an event, at least one of a scheme of sequential detection during output of the analysis target log 10 and a scheme of post-detection after output of the analysis target log 10 can be used.

(1) Sequential Detection

In the case of sequential detection, the log input unit 110 and the format determination unit 120 receive logs in the analysis target log 10 sequentially (each by a predetermined number of logs) and perform format determination thereon. The correlation determination unit 130 sequentially compares the input logs, which have been sequentially input and whose format has been determined, with the correlation pattern P stored in the correlation storage unit 152 and counts the number of times of appearance of respective correlation patterns P in the input logs. Then, when the total value of times of appearance of the correlation pattern P associated with a certain event E0 (event ID) (or a ratio of the number of times of appearance of the correlation pattern P or a ratio of inclusion of all the correlation patterns P) becomes a predetermined threshold or greater, the event detection unit 140 detects that the known event E0 as the event E1 occurs and outputs information related to the event E0 and the event E1. With such a configuration, a sign of an event based on the presence of a pre-learned correlation pattern can be detected before the event E1 occurs.

(2) Post-Detection

In the case of post-detection, the log input unit 110 and the format determination unit 120 receive the entire logs in the analysis target log 10 within a time range to be analyzed (for example, within 10 minutes before or after the time designated by the user or the occurrence time of the event E1) and perform format determination thereon. The correlation determination unit 130 compares the input logs, whose format has been determined, with the correlation pattern P stored in the correlation storage unit 152 and counts the number of times of appearance of respective correlation patterns P in the input logs. Then, when the total value of times of appearance of the correlation pattern P associated with a certain event E0 (event ID) (or a ratio of the number of times of appearance of the correlation pattern P or a ratio of inclusion of all the correlation patterns P) is greater than or equal to a predetermined threshold, the event detection unit 140 detects that the known event E0 as the event E1 occurred and outputs information related to the event E0 and the event E1. With such a configuration, a status before and after the occurrence of the event E1 in the analysis target log 10 can be analyzed later, or the occurrence of the event E1 that has not been recognized can be found from the analysis target log 10.

The output of an event detection result by the event detection unit 140 is performed through display using the display device 20 connected to the log analysis system 100. The event detection unit displays information on an event, such as the content of the event E0, the occurrence time of the event E1, the logs before or after the event E1, the correlation pattern, and the like, on the display device 20. The output of the event detection result may be performed by using any method using a printer, a speaker, a lamp, or the like without being limited to the above.

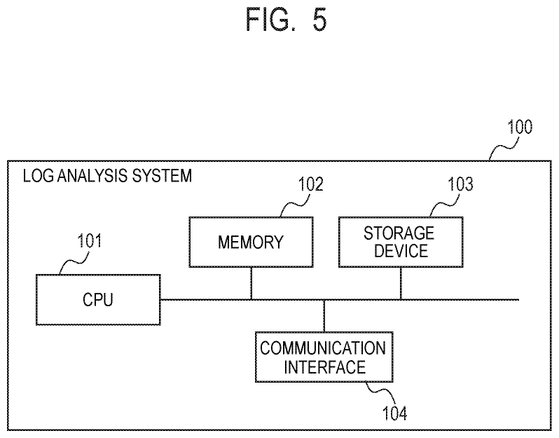

FIG. 5 is a general configuration diagram illustrating an exemplary device configuration of the log analysis system 100 according to the present example embodiment. The log analysis system 100 having a central processing unit (CPU) 101, a memory 102, a storage device 103, and a communication interface 104 may be a standalone device or configured integrally with another device.

The communication interface 104 is a communication unit that transmits and receives data and is configured to be able to execute at least one of the communication schemes of wired communication and wireless communication. The communication interface 104 includes a processor, an electric circuit, an antenna, a connection terminal, or the like required for the above communication scheme. The communication interface 104 is connected to a network using the communication scheme in accordance with a signal from the CPU 101 for communication. The communication interface 104 externally receives an analysis target log 10, for example.

The storage device 103 stores a program executed by the log analysis system 100, data of a process result obtained by the program, or the like. The storage device 103 includes a read only memory (ROM) dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor as a processing unit that temporarily stores temporary data used for processing in the memory 102, reads a program stored in the storage device 103, and executes various processing operations such as calculation, control, determination, or the like on the temporary data in accordance with the program. Further, the CPU 101 stores data of a process result in the storage device 103 and also transmits data of the process result externally via the communication interface 104.

In the present example embodiment, the CPU 101 functions as the log input unit 110, the format determination unit 120, the correlation determination unit 130, and the event detection unit 140 of FIG. 1 by executing a program stored in the storage device 103. Further, in the present example embodiment, the storage device 103 functions as the format storage unit 151 and the correlation storage unit 152 of FIG. 1.

The log analysis system 100 is not limited to the specific configuration illustrated in FIG. 5. The log analysis system 100 is not limited to a single device and may be configured such that two or more physically separated devices are connected by wired or wireless connection. Respective units included in the log analysis system 100 may be implemented by an electric circuitry, respectively. The electric circuitry here is a term conceptually including a single device, multiple devices, a chipset, or a cloud.

Further, at least a part of the log analysis system 100 may be provided as a form of Software as a Service (SaaS). That is, at least some of the functions for implementing the log analysis system 100 may be executed by software executed via a network.

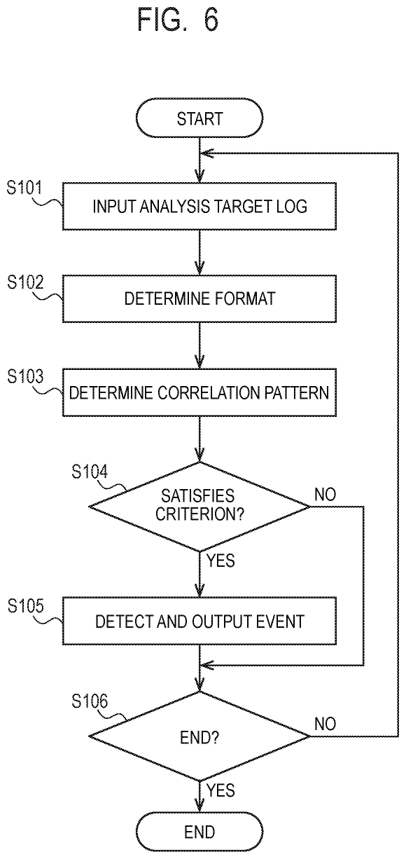

FIG. 6 is a diagram illustrating a flowchart of the log analysis method using the log analysis system 100 according to the present example embodiment. First, the log input unit 110 receives logs in the analysis target log 10 being output and inputs the received logs to the log analysis system 100 sequentially (each by a predetermined number of logs) (step S101). The format determination unit 120 determines which format stored in the format storage unit 151 each log included in the analysis target log 10 input in step S101 conforms to (step S102).

Next, the correlation determination unit 130 sequentially compares the logs whose format have been determined in step S102 with correlation patterns stored in the correlation storage unit 152 and counts the number of times of appearance of respective correlation patterns in the logs (step S103).

If a correlation pattern associated with a certain event (event ID) appears in the logs so as to satisfy a predetermined criterion (step S104, YES), the event detection unit 140 detects that the event occurs and outputs information on the event (step S105). As a detection criterion of an event, the total value of times of appearance of the correlation pattern, the ratio of the number of times of appearance of a correlation pattern to the number of logs, a ratio of inclusion of all the correlation patterns associated with a single event (event ID), or the like may be used as described above. If the correlation pattern does not appear in the logs so as to satisfy the predetermined criterion (step S104, NO), the process proceeds to step S106.

If the reception of the analysis target log 10 is not completed (step S106, NO), the process returns to step S101 to repeat from input of the analysis target log 10 to detection and output of an event. If the reception of the target analysis log 10 is completed (step S106, NO), the process ends.

While the flowchart of FIG. 6 illustrates the scheme of sequentially detecting during output of the analysis target log 10, when the scheme of detecting after the output of the analysis target log 10 is used, the entire analysis target log 10 within a time rage to be analyzed may be input in step S101.

The CPU 101 of the log analysis system 100 is a subject of each step (process) included in the log analysis method illustrated in FIG. 6. That is, the CPU 101 reads the program for executing the log analysis method illustrated in FIG. 6 from the memory 102 or the storage device 103, executes the program to control respective units of the log analysis system 100, and thereby performs the log analysis method illustrated in FIG. 6.

The log analysis system 100 according to the present example embodiment performs log analysis by using a correlation (a correlation pattern) between logs learned by correlation analysis from logs before or after a known event, and therefore the known event can be detected without prior knowledge of the log content (meaning of a log message or the like).

### Second Example Embodiment

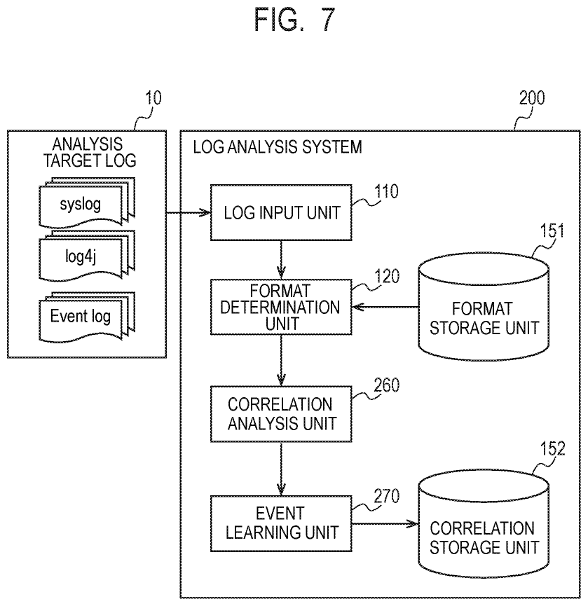

The present example embodiment is the invention relating to a learning method of a correlation (a correlation pattern) used in the first example embodiment. FIG. 7 is a block diagram of a log analysis system 200 according to the present example embodiment. The log analysis system 200 further has a correlation analysis unit 260 and an event learning unit 270, which are a processing unit, in addition to the log input unit 110, the format determination unit 120, the format storage unit 151, and the correlation storage unit 152 that are common to the log analysis system 100 according to the first example embodiment. The log analysis system 200 according to the present example embodiment may be integrated with the log analysis system 100 according to the first example embodiment.

The log input unit 110 and the format determination unit 120 perform format determination on the analysis target log 10 in the same manner as the first example embodiment. The correlation analysis unit 260 determines a correlation pattern P that appears before and after the known event E0 by using invariant analysis (correlation analysis) from the analysis target log 10 (the learning log L0 in FIG. 3). The event learning unit 270 stores the determined correlation pattern P as a learning result in the correlation storage unit 152. As the analysis target log 10, a log group output within a predetermined time range including the occurrence time of the event E0 is used. As a learning target, one or a plurality of log analysis target logs 10 may be used. The specific example of the correlation pattern P stored in the correlation storage unit 152 is the same as that in FIG. 4.

The known event E0 is a particular event to be detected such as an anomaly occurring in the system itself that has output a log, an anomaly detected by a monitoring system, an event which is normal but has to be detected, or the like. The occurrence time of the known event E0 may be the time (time stamp) of a single log corresponding to the event E0 in the analysis target log L0 or the occurrence time of the event E0 within the time range of the analysis target log 10 when there is no log corresponding to the event E0.

Specifically, with respect to logs within a predetermined time range (for example, within 10 minutes before and after the occurrence time of the event E0) including the occurrence time of the event E0 out of the analysis target log 10, the correlation analysis unit 260 calculates a transition probability between format IDs of the logs as a correlation coefficient. Here, the correlation analysis unit 260 calculates the transition probability for temporally adjacent two logs or all the combinations of two logs output within a predetermined time period (for example, within 10 seconds). The correlation analysis unit 260 then determines, as the correlation pattern P, a log group whose transition probability is greater than or equal to a predetermined threshold. The correlation pattern P is a permutation or a combination of correlated logs (format IDs). The transition probability is a probability at which a first type of logs appears and then a second type of logs appears in the analysis target log 10 (or the opposite thereto) and is a larger value for a larger number of times of occurrence of the permutation or the combination thereof. In other words, in the logs before or after the event E0, the correlation analysis unit 260 determines a correlation between logs from time series data of the number of times of occurrence of each type of logs. The event learning unit 270 stores the determined correlation pattern P in the correlation storage unit 152 together with information used for identifying the event E0. While the format ID of logs has been used for calculating a correlation coefficient between logs in the present example embodiment, any value that can represent characteristics of logs, such as a variable value included in a log, a combination of a format ID and a variable value, or the like may be used.

As a learning method of a correlation pattern, without being limited to the invariant analysis illustrated here, any method that can learn a correlation between logs from time series data of logs before or after the known event E0 may be used.

The correlation analysis unit 260 may determine, out of log groups whose transition probability is greater than or equal to a predetermined threshold, only the log group highly related to the event E0 as the correlation pattern P. Specifically, the degree of association with the event E0 can be determined by whether or not a log group whose transition probability is greater than or equal to a predetermined threshold appears outside the predetermined time range including the event E0 (for example, 10 minutes before and after the occurrence time of the event E0). That is, even in a case of a log group whose transition probability is greater than or equal to a predetermined threshold, a log group appearing outside the predetermined time range including the event E0 is not determined as the correlation pattern P. With such a configuration, a log group occurring independently of the event E0 is excluded from the determination of the correlation pattern P, and only the correlation pattern P closely associated with the known event E0 can be learned.

When a plurality of analysis target logs 10 are input from the log input unit 110, the correlation analysis unit 260 may determine, out of log groups whose transition probability is greater than or equal to a predetermined threshold, a log group appearing in both two or more analysis target logs 10 as the correlation pattern P. The number of analysis target logs 10 that is a determination criterion of the correlation pattern P may be any number of two or more. With such a configuration, since learning can be performed based on the plurality of analysis target logs 10 acquired at different time, the known event E0 can be more accurately detected.

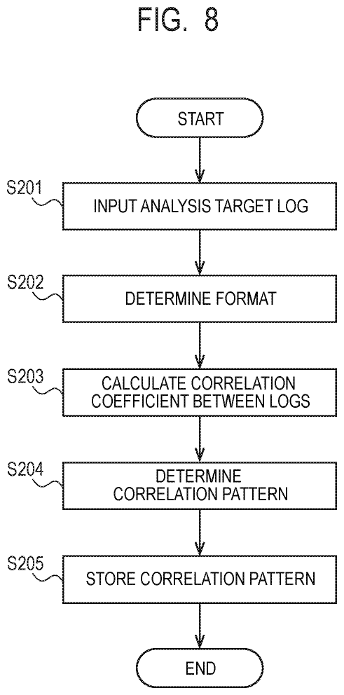

FIG. 8 is a diagram illustrating a flowchart of the learning method using the log analysis system 200 according to the present example embodiment. First, the log input unit 110 receives logs in the analysis target logs 10 within a predetermined time range including the occurrence time of a known event and inputs the received logs to the log analysis system 100 (step S201). The format determination unit 120 determines which format stored in the format storage unit 151 each log included in the analysis target logs 10 input in step S201 conforms to (step S202).

Next, the correlation analysis unit 260 calculates a correlation coefficient between logs (here, a transition probability) from the logs whose formats have been determined in step S202 (step S203) and determines, as a correlation pattern, a log group whose correlation coefficient calculated in step S203 is greater than or equal to a predetermined threshold (step S204).

Finally, the event learning unit 270 stores the correlation pattern determined in step S204 in the correlation storage unit 152 together with information that identifies the event (step 205).

The CPU 101 of the log analysis system 100 is a subject of each step (process) included in the learning method illustrated in FIG. 8. That is, the CPU 101 reads the program for executing the learning method illustrated in FIG. 8 from the memory 102 or the storage device 103, executes the program to control respective units of the log analysis system 100, and thereby performs the learning method illustrated in FIG. 8.

The log analysis system 200 according to the present example embodiment learns a correlation (a correlation pattern) between logs by correlation analysis from logs before or after a known event, and therefore the known event can be detected without prior knowledge of the log content (meaning of a log message or the like).

### Third Example Embodiment

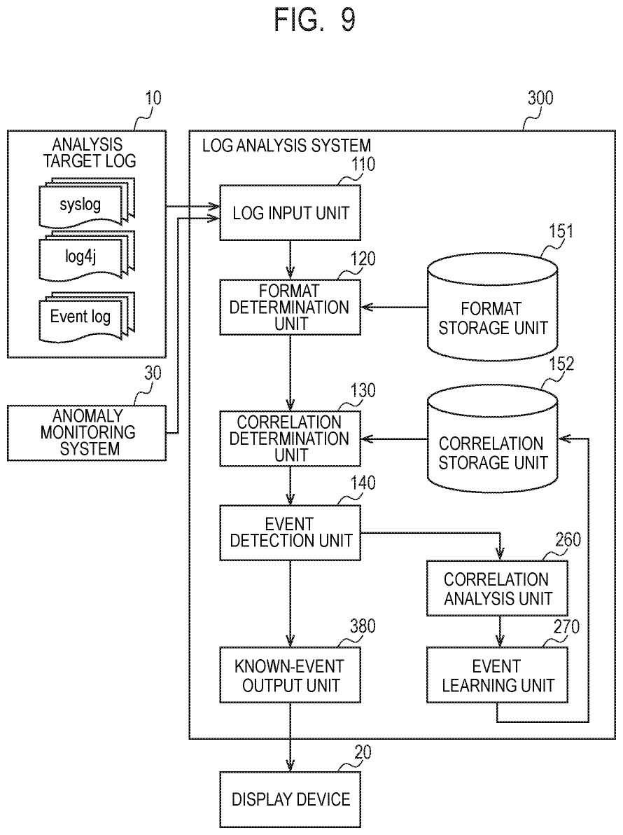

The present example embodiment uses a correlation pattern to determine whether an event such as an anomaly detected by a monitoring system or the like is known or unknown and performs different processes based on the determination result. FIG. 9 is a block diagram of a log analysis system 300 according to the present example embodiment. The log analysis system 300 further has a known-event output unit 380, which is a processing unit, in addition to the log input unit 110, the format determination unit 120, the correlation determination unit 130, the event detection unit 140, the format storage unit 151, and the correlation storage unit 152 that are common to the log analysis system 100 according to the first example embodiment and the correlation analysis unit 260 and the event learning unit 270 that are common to the log analysis system 100 according to the second example embodiment. The log analysis system 300 according to the present example embodiment may be integrated with the log analysis systems 100 and 200 according to the first and second example embodiments.

The log analysis system 300 is connected to an anomaly monitoring system 30 that detects occurrence of an anomaly (event). When the anomaly monitoring system 30 detects an anomaly, the log input unit 110 receives anomaly information including occurrence time of the anomaly from the anomaly monitoring system 30. The anomaly monitoring system 30 may detect a particular event to be detected without limited to detect an anomaly. The log input unit 110 then inputs the analysis target logs 10 output within a predetermined time range including occurrence time of an anomaly detected by the anomaly monitoring system 30 in the log analysis system 300. The format determination unit 120 performs format determination on the analysis target log 10 in the same manner as the first example embodiment.

The correlation determination unit 130 performs comparison on each log group in the analysis target log 10 to determine whether or not to be the same as or similar to the correlation pattern P stored in the correlation storage unit 152. The determination of being similar to the correlation pattern P is performed with any rule such as determining that a ratio of matching to the plurality of logs (formats) included in the correlation pattern P is greater than or equal to a predetermined threshold, determining that the plurality of logs (formats) included in the correlation pattern P have been rearranged, or the like.

Then, when the correlation pattern P associated with the known event E0 appears in the analysis target log 10 so as to satisfy a predetermined criterion, the event detection unit 140 detects that the anomaly detected by the anomaly monitoring system 30 is the known event E0, otherwise, detects that the anomaly is an unknown event. The specific detection method of the correlation pattern P is the same as that in the first example embodiment.

When it is detected by the event detection unit 140 that the anomaly notified from the anomaly monitoring system 30 is the known event E0, the known-event output unit 380 outputs information on the known event E0 by using the display device 20. As information on the known event E0, for example, the date and time when the known event E0 occurred in the past, the content of the known event E0, a countermeasure taken to the known event E0, or the like may be output. The information on the known event E0 may be acquired from information pre-stored in the correlation storage unit 152 or may be acquired from the outside of the log analysis system 300.

When it is detected by the event detection unit 140 that the anomaly notified from the anomaly monitoring system 30 is an unknown event, the correlation analysis unit 260 and the event learning unit 270 perform learning of the correlation pattern P on the analysis target log 10 in the same manner as in the second example embodiment so that the anomaly notified from the anomaly monitoring system 30 is defined as a known event. The learned correlation pattern P is stored in the correlation storage unit 152. Furthermore, when the anomaly notified from the anomaly monitoring system 30 is an unknown event, the display device 20 may be used to output that the detected anomaly is unknown one.

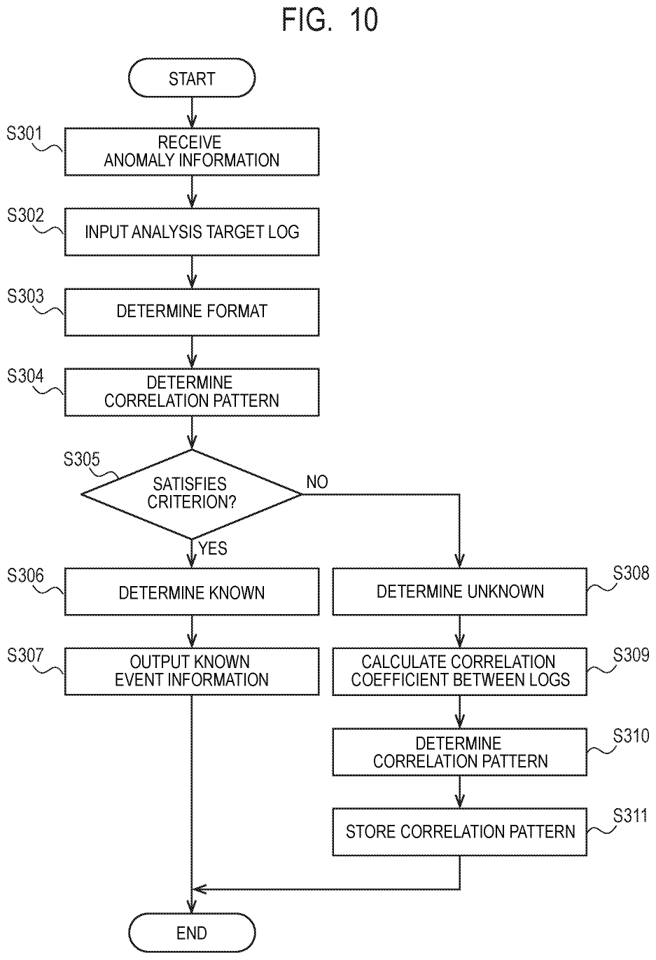

FIG. 10 is a diagram illustrating a flowchart of the log analysis method using the log analysis system 300 according to the present example embodiment. First, the log input unit 110 receives anomaly information including the occurrence time of an anomaly from the anomaly monitoring system 30 (step S301). The log input unit 110 then receives logs in the analysis target logs 10 within a predetermined time rage including the occurrence time of the anomaly received in step S301 and inputs the received logs to the log analysis system 300 (step S302). The format determination unit 120 determines which format stored in the format storage unit 151 each log included in the analysis target log 10 input in step S301 conforms to (step S303).

Next, the correlation determination unit 130 compares the logs whose format have been determined in step S303 with correlation patterns stored in the correlation storage unit 152 and counts the number of times of appearance of respective correlation patterns in the logs (step S304).

If a correlation pattern associated with a certain event (event ID) appears in the logs so as to satisfy a predetermined criterion (step S305, YES), the event detection unit 140 detects that the anomaly detected by the anomaly monitoring system 30 is a known event (step S306). Next, the known-event output unit 380 outputs information on the known event determined in step S306 by using the display device 20 (step S307).

If the correlation pattern does not appear in the logs so as to satisfy the predetermined criterion (step S305, NO), the event detection unit 140 detects that the anomaly detected by the anomaly monitoring system 30 is an unknown event (step S308). Next, the correlation analysis unit 260 calculates a correlation coefficient between logs (here, a transition probability) from the logs whose formats have been determined in step S303 (step S309). The correlation analysis unit 260 then determines, as a correlation pattern, a log group whose correlation coefficient calculated in step S309 is greater than or equal to a predetermined threshold (step S310).

The event learning unit 270 then stores the correlation pattern determined in step S310 in the correlation storage unit 152 together with information that identifies the event (that is, the anomaly detected by the anomaly monitoring system 30) (step S311). Further, the display device 20 may be used to output the indication that the detected anomaly is unknown one.

The CPU 101 of the log analysis system 100 is a subject of each step (process) included in the learning method illustrated in FIG. 10. That is, the CPU 101 reads the program for executing the learning method illustrated in FIG. 10 from the memory 102 or the storage device 103, executes the program to control respective units of the log analysis system 100, and thereby performs the learning method illustrated in FIG. 10.

The log analysis system 300 according to the present example embodiment determines whether an anomaly detected by an anomaly monitoring system is known or unknown based on a correlation (a correlation pattern) between logs learned from a known event, and it is therefore possible to know whether the anomaly is known one or unknown one even when the direct cause of the anomaly is unknown. Furthermore, since information on an associated known event is output when the detected anomaly is known, it becomes easier to investigate the cause of the anomaly or take a countermeasure to the anomaly. Furthermore, when the detected anomaly is unknown one, it is possible to learn the correlation pattern from logs before or after the anomaly and notify the user that the anomaly is an unknown anomaly.

### Other Example Embodiments

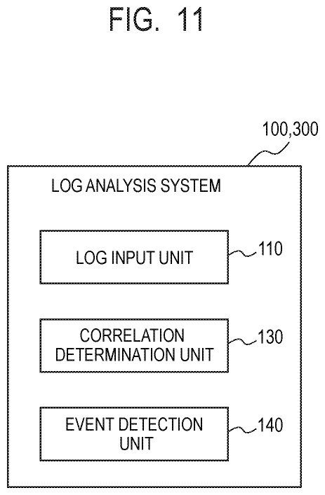

FIG. 11 is a schematic configuration diagram of the log analysis systems 100 and 300 according to each example embodiment described above. FIG. 11 illustrates a configuration example by which the log analysis systems 100 and 300 function as a device that determines a similarity to a known event by determining the presence or absence of a pre-stored time series correlation (a correlation pattern) in the analysis target log 10 and detects the known event. The log analysis systems 100 and 300 have the log input unit 110 that inputs an analysis target log including a plurality of logs, the correlation determination unit 130 that determines the presence or absence of a time series correlation between the plurality of logs within a predetermined time range before or after an event, and the event detection unit 140 that detects the event based on a result of the determination.

The present invention is not limited to the example embodiments described above and can be properly changed within the scope not departing from the spirit of the present invention.

Further, the scope of each of the example embodiments includes a processing method that stores, in a storage medium, a program that causes the configuration of each of the example embodiments to operate so as to implement the function of each of the example embodiments described above (more specifically, a log analysis program that causes a computer to perform the process illustrated in FIG. 6, FIG. 8, or FIG. 10), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A log analysis method including steps of:

inputting at least one analysis target log including a plurality of logs;

determining presence or absence of a time series correlation between the plurality of logs within a predetermined time range before or after an event; and

detecting the event based on a result of the determination.

(Supplementary Note 2)

The log analysis method according to supplementary note 1, wherein the step of determining determines the presence or absence of the correlation in the analysis target log by performing comparison to determine whether or not the correlation stored in advance and the plurality of logs are the same as or similar to each other.

(Supplementary Note 3)

The log analysis method according to supplementary note 1 or 2, wherein the step of detecting detects the event based on the number of the plurality of logs that are the same as or similar to the correlation.

(Supplementary Note 4)

The log analysis method according to any one of supplementary notes 1 to 3,

wherein the step of inputting sequentially inputs the plurality of logs in the analysis target log, and

wherein the step of detecting detects a sign of occurrence of the event when the plurality of logs that are the same as or similar to the correlation appear in the plurality of the sequentially input logs.

(Supplementary Note 5)

The log analysis method according to any one of supplementary notes 1 to 3, wherein the step of detecting identifies that the event is known when it is determined that the correlation is present in the step of determining and, otherwise, identifies that the event is unknown.

(Supplementary Note 6)

The log analysis method according to any one of supplementary notes 1 to 5 further including a step of: determining which of a plurality of predetermined forms each log included in the analysis target log matches, the plurality of predetermined forms including a variable part that varies and a constant part that does not vary,

wherein the step of determining determines presence or absence of the correlation in time series between the forms.

(Supplementary Note 7)

The log analysis method according to any one of supplementary notes 1 to 6 further including a step of: learning the correlation in time series between the plurality of logs within a predetermined time range before or after a known event.

(Supplementary Note 8)

The log analysis method according to supplementary note 7, wherein the step of learning calculates a transition probability between the plurality of logs and learns, as the correlation, the plurality of logs having the transition probability greater than or equal to a predetermined threshold.

(Supplementary Note 9)

The log analysis method according to supplementary note 7 or 8, wherein the step of learning learns, out of the plurality of logs, a log highly related to the event as the correlation.

(Supplementary Note 10)

The log analysis method according to supplementary 7 or 8,

wherein the step of inputting inputs a plurality of analysis target logs, and

wherein the step of learning learns, as the correlation, a log appearing commonly to the plurality of analysis target logs out of the plurality of logs.

(Supplementary Note 11)

A log analysis program that causes a computer to execute steps of:

inputting at least one analysis target log including a plurality of logs;

determining presence or absence of a time series correlation between the plurality of logs within a predetermined time range before or after an event; and

detecting the event based on a result of the determination.

(Supplementary Note 12)

A log analysis system comprising:

a log input unit that inputs at least one analysis target log including a plurality of logs;

a correlation determination unit that determines presence or absence of a time series correlation between the plurality of logs within a predetermined time range before or after an event; and

an event detection unit that detects the event based on a result of the determination.

What is claimed is:

1. A log analysis method including steps of:
inputting at least one analysis target log including a plurality of logs;
determining presence or absence of a time series correlation between the plurality of logs within a predetermined time range before or after an event; and
detecting the event based on a result of the determination.

2. The log analysis method according to claim 1, wherein the step of determining determines the presence or absence of the correlation in the analysis target log by performing comparison to determine whether or not the correlation stored in advance and the plurality of logs are the same as or similar to each other.

3. The log analysis method according to claim 1, wherein the step of detecting detects the event based on the number of the plurality of logs that are the same as or similar to the correlation.

4. The log analysis method according to claim 1,
wherein the step of inputting sequentially inputs the plurality of logs in the analysis target log, and
wherein the step of detecting detects a sign of occurrence of the event when the plurality of logs that are the same as or similar to the correlation appear in the plurality of the sequentially input logs.

5. The log analysis method according to claim 1, wherein the step of detecting identifies that the event is known when it is determined that the correlation is present in the step of determining and, otherwise, identifies that the event is unknown.

6. The log analysis method according to claim 1 further including a step of: determining which of a plurality of predetermined forms each log included in the analysis target log matches, the plurality of predetermined forms including a variable part that varies and a constant part that does not vary,
wherein the step of determining determines presence or absence of the correlation in time series between the forms.

7. The log analysis method according to claim 1 further including a step of: learning the correlation in time series between the plurality of logs within a predetermined time range before or after a known event.

8. The log analysis method according to claim 7, wherein the step of learning calculates a transition probability between the plurality of logs and learns, as the correlation, the plurality of logs having the transition probability greater than or equal to a predetermined threshold.

9. The log analysis method according to claim 7, wherein the step of learning learns, out of the plurality of logs, a log highly related to the event as the correlation.

10. The log analysis method according to claim 7,
wherein the step of inputting inputs a plurality of analysis target logs, and
wherein the step of learning learns, as the correlation, a log appearing commonly to the plurality of analysis target logs out of the plurality of logs.

11. A non-transitory storage medium in which a log analysis program is stored, the log analysis program causing a computer to execute steps of:
inputting at least one analysis target log including a plurality of logs;
determining presence or absence of a time series correlation between the plurality of logs within a predetermined time range before or after an event; and
detecting the event based on a result of the determination.

12. A log analysis system comprising:
a log input unit that inputs at least one analysis target log including a plurality of logs;
a correlation determination unit that determines presence or absence of a time series correlation between the plurality of logs within a predetermined time range before or after an event; and
an event detection unit that detects the event based on a result of the determination.
